(19) United States
(12) Patent Application Publication
(10) Pub. No.: US 2025/0262702 A1
(43) Pub. Date: Aug. 21, 2025

(54) ELECTRICALLY POWERED CONSTRUCTION EQUIPMENT COMPRISING A VIBRATION DEVICE

(71) Applicant: HUSQVARNA AB, Huskvarna (SE)

(72) Inventors: Niklas SUNDBERG, Alingsas (SE); Andreas JONSSON, Hallsberg (SE)

(21) Appl. No.: 18/858,462

(22) PCT Filed: Apr. 17, 2023
(86) PCT No.: PCT/SE2023/050349

§ 371 Date: Oct. 21, 2024

(30) Foreign Application Priority Data
Apr. 21, 2022 (SE) 2250479-9

(51) Int. Cl. B23Q 5/04; B23Q 5/10

(52) U.S. Cl. CPC B23Q 5/043; B23Q 5/10

(57) ABSTRACT

Electrically powered construction equipment (100, 1200, 1300, 1400, 1500) comprising an electric motor (120) arranged to power an abrasive cutting tool (130) via a drive arrangement (200), the abrasive cutting tool (130) comprising abrasive elements (131) arranged on a carrier (132) of the cutting tool (130), where the abrasive elements (131) are arranged distanced from each other on the carrier (132) and follow a closed path during operation of the construction equipment, the construction equipment (100, 1200, 1300, 1400, 1500) further comprising a vibration device (120, 300, 350, 400, 500, 600, 700, 800) arranged to generate a controlled amount of vibration of the abrasive cutting tool (130), wherein the vibration is generated in a frequency band below 15 kHz.

### TECHNICAL FIELD

The present disclosure relates to hand-held electric power cutters and other abrasive tools for cutting hard materials such as concrete and stone. Although the techniques discussed herein are primarily intended for use with power cutters, the techniques may also find application in other types of electrically powered construction equipment for cutting concrete and stone, such as core drills and wall saws.

### BACKGROUND

Power cutters are hand-held construction equipment designed for cutting hard materials such as concrete and stone by a rotatable abrasive cutting disc. Power cutters have traditionally been powered by a combustion engine. However, electrically powered machines are also known, and battery powered machines are becoming increasingly common.

WO 2021/107827 A1 discloses an example electric power cutter.

There is a desire to improve the cutting performance of electric power cutters and other electrically powered construction equipment.

### SUMMARY

It is an objective of the present disclosure to increase the cutting performance of electric power cutters and other electrically powered construction equipment. This objective is obtained by the herein disclosed electrically powered construction equipment which comprises an electric motor arranged to power an abrasive cutting tool via a drive arrangement. The abrasive cutting tool comprises abrasive elements arranged on a carrier of the cutting tool, where the abrasive elements are arranged distanced from each other on the carrier to follow a closed path during operation of the construction equipment. The construction equipment furthermore comprises a vibration device arranged to generate a controlled amount of vibration of the abrasive cutting tool. The vibration is generated in a frequency band below 15 kHz, i.e., the vibration is a non-ultrasonic vibration which in some examples emulates the vibration generated by a combustion engine in use, and in some other example is tailored for sharpening abrasive elements on the cutting tool. This vibration device generates vibrations which propagate to the abrasive elements which affects the cutting performance by the cutting tool in a positive manner. The vibrations make the cutting operation more similar to that obtained from construction equipment powered by combustion engines where the vibration may clean the abrasive tool as it enters into the work object. The vibration which is generated is preferably non-uniform, i.e., irregular or random in nature. This type of randomness in the vibration pattern may improve the performance of the construction equipment.

In some examples the vibration is generated at frequencies below 5 kHz, or even below 1 kHz. This type of vibration is type of mechanical vibration that emulates the vibration generated by a combustion engine in use.

The vibration device can be arranged to be activated and deactivated in response to a user input signal, such as an input signal from a control button or the like. This allows the user to activate the vibration function or choose to operate the tool without vibration in dependence of preference and/or in dependence of the cutting task to be performed. The function can also be used with advantage to temporarily activate the vibration in order to sharpen the abrasive elements on the abrasive cutting tool. Automatic activation and deactivation of the vibration device are also discussed herein.

The vibration device is optionally also arranged to generate vibration at a configurable amplitude and/or frequency. The amplitude and/or frequency can, for instance, be optimized for a given work task, or according to user preference, which is an advantage. The vibration device can also be arranged to generate vibration in a radial and/or in an axial direction with respect to the tool axle, depending on work task and/or user preference. Certain machine types also benefit from different direction vibration. The vibration characteristics can be pre-configured or be adjusted during operation in response to user input. It is noted that the vibration need not be generated at a fixed frequency and/or at a fixed amplitude. Advantages can in some cases be obtained by varying the frequency content and/or amplitude of the generated vibration in a non-uniform manner over time, i.e., adding a measure of randomness to the generated vibration. A pseudo-noise sequence can be used to generate such a non-uniform or random vibration.

The vibration device is preferably arranged in connection to a tool axle of the construction equipment and distanced from other parts of the equipment such as the handles. The main purpose of adding vibration is to improve cutting efficiency by adding a controlled amount of vibration to the cutting tool during operation. Thus, vibration in the tool itself is to be promoted, which can be done by arranging the vibration device close to the tool axle. At the same time, vibration may be undesired in other parts of the equipment, such as in handles and in connection to sensitive control circuitry and the like. Thus, vibration in parts of the equipment other than the tool may be desired to suppress, which can be done by arranging the vibration device close to the tool axle.

The controlled amount of vibration is a non-ultrasonic vibration in a frequency band below 15 kHz, and in most examples below 5 kHz or even below 1 kHz. This type of non-ultrasonic vibration has been found to improve cutting efficiency of the abrasive cutting tool 130, at least in part since the vibration cleans the abrasive elements 131 during operation, and often also since the vibration improves the interaction between the abrasive elements 131 and the work object to be processed by the construction equipment. Thus, the controlled amount of vibration generated by the vibration device of the present disclosure is fundamentally different from the ultrasonic vibration generated by the tool in JPH0482609A which is at much higher frequency. The purpose of the ultrasonic vibration generated by the tool in JPH0482609A is to pulverize work object debris in the cut, not to improve the performance of the tool, hence the difference in vibration frequency band.

The vibration device can be arranged to be driven by the main electric motor of the construction equipment, or by a motor and/or solenoid device which is separate from the main electric motor of the construction equipment. Combinations of vibration drive arrangements are of course also possible. A benefit of using a separate electric motor and/or solenoid device to generate vibration is that the vibration can be controlled independently from the main motor operation.

The vibration device can be of simple construction, such as comprising a mass and spring arrangement. These arrangements are robust and also of low cost.

The main electric motor of the construction equipment may also constitute the vibration device. In other words, the main drive motor can in itself be used to generate a controlled amount of vibration. This is an advantage since no additional hardware is then required in order to generate vibration. A control unit arranged to control the main electric motor at a target speed can for instance be programmed to introduce a variation over time in the target speed. This way it becomes possible to control the frequency of the vibration by modulating an axle speed command over time. The control unit can also be arranged to control an amplitude of the vibration by modulating the axle speed command over time, which is an advantage.

According to some aspects, the electrically powered construction equipment comprises an inertial measurement unit (IMU) arranged to output a signal indicative of the vibration. The control unit can then be arranged to control the main electric motor based on the IMU output signal to obtain a desired frequency and/or amplitude of vibration. This is a feedback system, in which the effects of a given applied vibration is measured in the tool and fed back to the control unit. The control unit can then modulate the vibration in terms of, e.g., magnitude and frequency content in order to obtain a desired vibration pattern close to the tool, which is an advantage. The feedback signal can also be used to ensure that the vibration magnitude does not exceed some allowable maximum vibration magnitude level.

The electrically powered construction equipment may furthermore comprise a user interface configured to trigger activation and deactivation of the vibration device. This user interface can be a digital interface with a menu system where the function can be activated, and also a more simple button or control knob which a user can operate to activate and inactivate the vibration function. The interface can of course also be used to control the frequency and/or a magnitude of the generated vibration. For instance, a control knob can be turned by a user in order to increase vibration magnitude and/or frequency, similar to the volume controls of a stereo system.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where

FIG. 1 shows an example electric power cutter;

FIG. 2 illustrates an example drive arrangement for a power cutter;

FIGS. 3A-C illustrate example cam arrangements for generating vibration;

FIGS. 4-7 show example mechanisms for generating vibration;

FIG. 8A schematically illustrates an electric motor control system;

FIG. 8B-C show example electric motor target speed variation patterns;

FIG. 9 is a flow chart illustrating methods;

FIG. 10 illustrates a control unit comprising processing circuitry;

FIG. 11 illustrates a computer program product;

FIG. 12 illustrates an example wall saw;

FIG. 13 shows an example core drill;

FIG. 14 shows an example ring power cutter; and

FIG. 15 illustrates an abrasive chain saw.

### DETAILED DESCRIPTION

The invention will now be described more fully hereinafter with reference to the accompanying drawings, in which certain aspects of the invention are shown. This invention may, however, be embodied in many different forms and should not be construed as limited to the embodiments and aspects set forth herein; rather, these embodiments are provided by way of example so that this disclosure will be thorough and complete, and will fully convey the scope of the invention to those skilled in the art. Like numbers refer to like elements throughout the description.

It is to be understood that the present invention is not limited to the embodiments described herein and illustrated in the drawings; rather, the skilled person will recognize that many changes and modifications may be made within the scope of the appended claims.

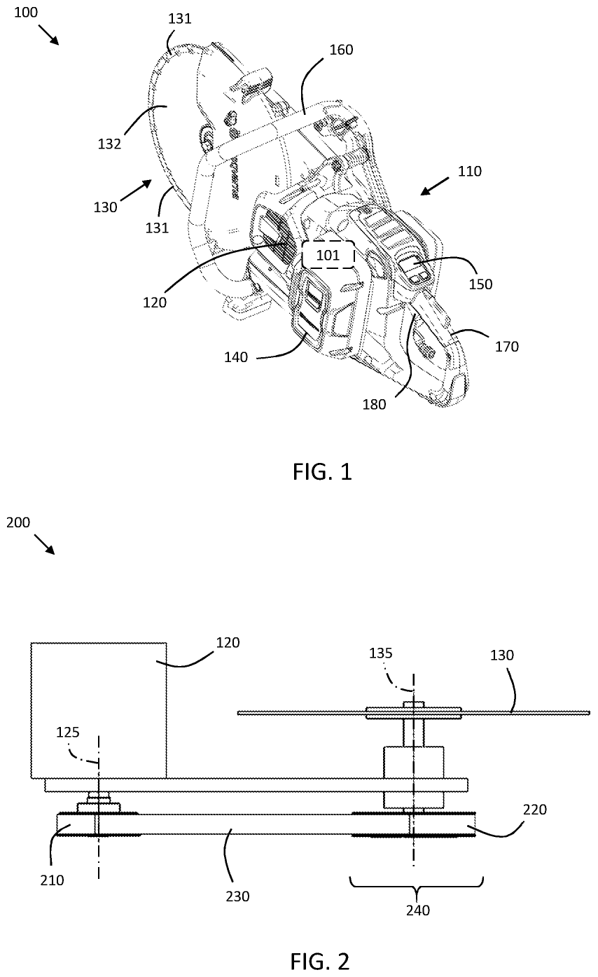

FIG. 1 shows an example power cutter 100, i.e., a hand-held work tool for cutting hard material work objects such as concrete and stone. The power cutter 100 comprises a main body 110 with a motor 120 connected to a rotatable circular abrasive cutting tool 130 via a drive arrangement comprised in a power cutter tool arm. The abrasive cutting tool 130 comprises abrasive elements 131 arranged on a carrier 132 of the cutting tool 130 which in this case is a disc. The abrasive elements 131 are arranged distanced from each other on the carrier 132 and follow a closed circular path during operation of the construction equipment in a known manner. The power cutter is operated by a trigger device 180.

This particular example of a power cutter is a battery powered electric machine with an electric motor that draws its energy from a rechargeable battery 140. Electric power cutters which are powered via cable from electrical mains are also known.

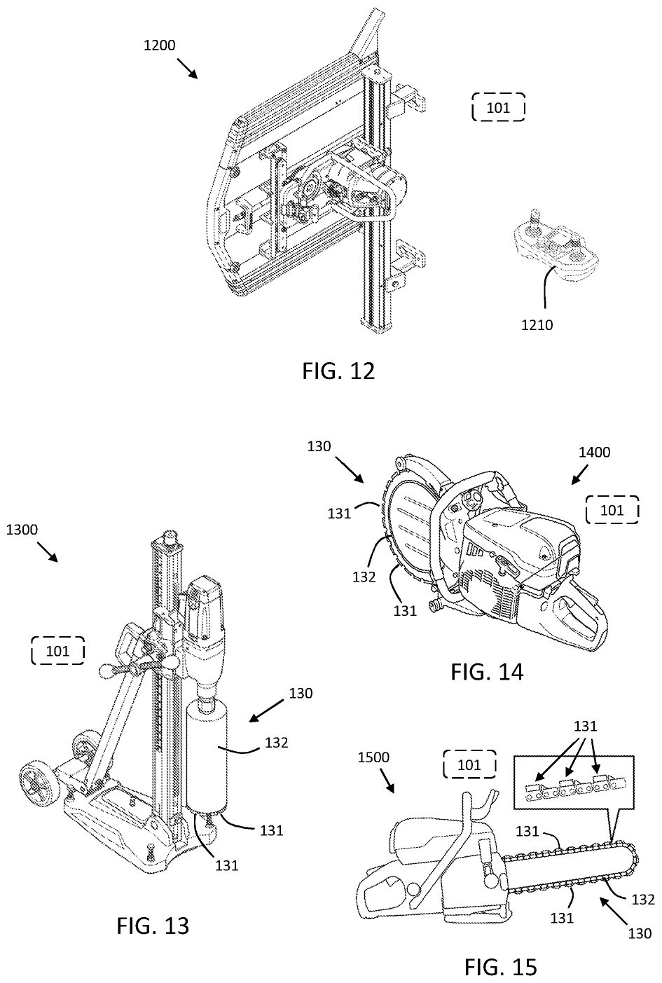

The power cutter 100 is an example of electrically powered construction equipment. Other examples of electrically powered construction equipment comprise wall saws 1200, core drills 1300, abrasive ring power cutters 1400 and abrasive chain saws 1500 as illustrated in FIG. 12 through FIG. 15. These tools all comprise abrasive cutting tools 130 where abrasive elements 131 have been arranged on respective carriers 132 of the cutting tools 130. The abrasive elements 131 are arranged distanced from each other on the carrier 132 and follow a closed path during operation of the construction equipment. The wall saw 1200 in FIG. 12 has a carrier in the form of a circular saw blade (not visible in FIG. 12) similar to that of the power cutter 100, where abrasive elements have been arranged along the perimeter of the saw blade. The core drill 1300 has a cylindrically shaped carrier 132 where abrasive elements 131 have been arranged along the lower rim of the drill bit as shown in FIG. 13. The ring saw 1400 has a ring-shaped rotatable carrier 132, where the abrasive elements 131 have been arranged along the perimeter of the ring. The chain saw 1500 has a saw blade supporting a chain constituting the carrier 132. Abrasive elements 131 are mounted to the chain which is slidably supported by the saw blade in a known manner. The abrasive cutting tool 130 in all examples 100, 1200, 1300, 1400, 1500, comprises abrasive elements 131 arranged on a carrier 132 of the cutting tool 130. The abrasive elements 131 are arranged distanced from each other on the carrier 132 and follow a closed path during operation of the construction equipment, i.e., a path starting and stopping in the same point. The abrasive elements engage the work object to be abraded or cut along this closed path.

The abrasive elements preferably comprise diamonds or granules of some other hard material such as carbide.

Some of the construction equipment discussed herein is arranged to cut into the work object using abrasive elements arranged along the perimeter of a rotatable circular cutting tool such as a saw blade, a core drill bit, or a power cutter ring. Other examples of construction equipment instead uses a chain to support the abrasive elements. The power cutter 100, the wall saw 1200, the ring saw 1400 and the abrasive chain saw 1500 all have saw blades which generate a cut (sometimes also referred to as a kerf) having a length that substantially exceeds a width of the cut. The width of this cut is determined by the width of the abrasive elements measured axially. The length of the cut depends on how the blade is moved with respect to the work object and is not dependent on the shape of the tool. The core drill 1300 also generates a cut or kerf which has a length that substantially exceeds its width, as opposed to the circular hole generated by a normal rotatable drill. The width of the cut is again determined by the width of the abrasive elements, while the length of the cut equals the circumference of the core drill bit. The construction equipment discussed herein is fundamentally different from regular twist drills that generate circular holes by a cutting action rather than an abrasive action. One factor which distinguishes the construction equipment discussed herein from normal twist drills is that the plurality of abrasive elements follow a closed path in a plane, i.e., a path which starts and ends in the same point on the plane, where the abrasive elements are separated from each other when travelling along the path. The abrasive elements on the saw blade of a power cutter 100 or wall saw 1200, or the abrasive elements on a core drill bit 1300, or the abrasive elements on the ring of the ring cutter 1400 follow a circular closed path centered on and distanced from the rotation axis of the tool, while the abrasive elements on the abrasive chain of the chain saw 1500 follow an elliptic closed path in a plane of the saw blade, as shown in FIG. 15.

The power cutter 100, the wall saw 1200, the core drill 1300 and the ring saw 1400 comprise abrasive elements which engage the work object at a distance from an axis of rotation of the rotatable circular tools.

Referring again to FIG. 1, the power cutter 100 comprises a user interface 150 with input/output (I/O) means and a display device, where a user of the tool 100 can input various types of configuration data for operating the machine and also receive status messages and the like. The I/O device may comprise buttons, light-emitting-diode (LED) indicators, a buzzer and also a radio transceiver circuit arranged to communicate with a remote device such as a server or an external wireless device such as a tablet or smart phone. The term I/O device should be construed broadly to incorporate any type of interface towards a user or remote device.

FIG. 2 illustrates an example drive arrangement 200 for driving a saw blade, such as the saw blade 130. The drive arrangement 200 comprises a first pulley 210 arranged to be driven by a motor axle 125 of an electric motor 120. A torque applied to the motor axle 125 is transferred via the first pulley 210 to a drive belt 230 which in turn drives a second pulley 220. The second pulley 220 is connected to a tool axle 135, whereby the circular cutting tool 130 is brought into rotation by the torque applied to the motor axle 125 by the electric motor 120.

Combustion engine powered construction equipment, such as power cutters driven by combustion engines, generate an amount of vibration by the engine which propagates to the different parts of the machine. Vibration at the tool handles 160, 170 is undesired since it can be harmful to the operator. Vibration at the control unit 101 or battery 140 may also be undesired since strong vibration may reduce the lifetime of such components.

However, for certain work tasks, vibration from the combustion engine which propagates to the tool 130 may improve the efficiency of the cutting operation by the tool 130. It has been observed that electrically powered construction equipment sometimes exhibit a reduced cutting efficiency compared to otherwise equivalent combustion engine powered equipment. For some work tasks, the combustion powered machine performs better than the electrically powered machine, despite the two machines having identical abrasive tools and the same drive power. The reason for the reduced cutting efficiency which is sometimes seen in electrically powered equipment is at least in part due to the reduced amount of vibration in an electrically powered machine where no combustion engine vibration is present.

This deficiency of electrically powered construction equipment such as electric power cutters, wall saws and core drills can be alleviated by introducing a vibration device in the machine which is arranged to generate a controlled amount of vibration of the cutting tool 130. This vibration device “emulates” the vibration which would have been present had a combustion engine powered the machine, and may improve the cutting efficiency of the tool in some cases. The vibration device is preferably arranged to be activated and deactivated in response to a user input signal, e.g., obtained via a user interface 150 configured to trigger activation and deactivation of the vibration device. For instance, the machine 100, 1200, 1300 may comprise a vibration activation button or menu selection option which allows a user to activate the vibration function in order to evaluate if the cutting efficiency improves as a result of the vibration. This activation and deactivation function can be used with advantage to temporarily activate generation of the controlled amount of vibration in order to sharpen the abrasive elements 131 of the cutting tool 130, which may be particularly advantageous during use of a core drill. It is also possible to implement an automatic vibration activation mechanism that automatically activates the vibration device, e.g., by the control unit 101 in response to a trigger signal. The trigger signal may be, e.g., a signal from a configurable or preconfigured timer which results in a periodic activation and deactivation of the vibration device. The trigger signal may also be generated based on an output signal from an inertial measurement unit (IMU) or microphone configured to measure an operating characteristic of the abrasive cutting tool, and activate the vibration device in case the operating characteristic deviates from an expected or desired operating characteristic. The operating characteristics may, e.g., be associated with an expected amount of sound and/or vibration from the tool in use. This expected amount of sound and/or vibration from the tool in use can be determined by laboratory experimentation or by computer simulation. It can also be configured by the user of the equipment. The expected operating characteristic may comprise an amplitude and/or a frequency characteristic of a detected vibration or a generated sound in use. The expected operating characteristic may also comprise a measured amount of dust by the construction equipment, which can be measured by a scale, or a dust sensor arranged in connection to a dust extractor connected to the construction equipment. A reduction in the amount of generated dust may be indicative of a need for sharpening the abrasive elements 131. The expected operating characteristic may furthermore comprise an expected torque output of the motor 120 in use. The expected torque can also be preconfigured by practical experimentation in a laboratory or out in the field during use of the construction equipment.

The vibration device may also be configured to be activated only in a high speed range of the rotatable tool, i.e., the vibration function will only kick in as the tool approaches its working speed, and remain deactivated at idle or low speeds and also during ramping up to working speeds. This range where the vibration function becomes active may be above 70% of full tool speed or so. Alternatively, the range of tool speeds where the vibration device is activated can be set at, e.g., 40-80% of full speed. This way the vibration function starts when the tool has reached a certain working speed and then ceases again at close to full speed. Alternatively, the vibration function may be activated only at full throttle, i.e., when the user fully depresses the trigger 180. The vibration function can also be activated manually by some form of input control means, such as a button or control knob. A user can then activate the vibration function when and if the function is desired. The user can also use the input control means to control one or more properties of the vibration, such as its frequency or amplitude. It is also possible to implement one or more pre-defined vibration characteristics optimized beforehand for various work tasks. The user can then select between a number of options, perhaps in dependence of personal preference and/or in dependence of the work task to be performed.

The vibration device is preferably also arranged to generate vibration at a configurable amplitude and/or frequency. This allows a given machine type to be tailored or even optimized for a given cutting task, i.e., for cutting into a specific type of material. The amplitude and/or frequency of the generated vibration may be configured during assembly at the factory. Alternatively or as a complement, the amplitude and/or frequency of the vibration may be configurable by a user, e.g., via a menu selection in the user interface 150. The control may then comprise control of a frequency of the vibration and/or control of a magnitude or amplitude of the generated vibration. Herein, a vibration amplitude or magnitude relates to the strength of the generated vibration, i.e., how strong the vibration is compared to some reference level of vibration. The frequency of a vibration relates to the frequency content of the generated vibration. For example, the frequency of the vibration may relate to a maximum frequency of the generated vibration, or a width of a frequency band comprising a main part of the generated vibration, e.g., a 3 dB bandwidth of the vibration frequency power spectrum. Methods for implementing a vibration device allowing configuration of vibration amplitude and/or frequency will be described below.

With reference to FIG. 2, the vibration device is preferably arranged in connection to the tool axle 135 of the construction equipment, as illustrated by the bracket 240. It is an advantage to locate the vibration device close to the tool where the vibration is desired, and away from the handles of the machine where vibration is undesired. According to some aspects, the vibration device is arranged to be driven directly by the tool axle 135, or via the pulley 220, or by the belt 230. The vibration element may also be driven by the tool axle 135 indirectly via some form of transmission, such as a geared transmission or a separate drive belt arrangement. The advantage of having a transmission, such as a geared transmission in-between power source and vibration device is that the frequency can be adjusted relative to the rotation speed of the power source, such as the rotation speed of the tool axle 135.

It is appreciated that the vibration device can be driven directly or indirectly by the main electric motor 120 of the construction equipment, i.e., the electric motor which also powers the tool 130. A toothed belt may bring additional advantages to the design since a toothed belt is able to transfer abrupt changes in torque better to the tool than a non-toothed belt such as a v-belt or the like, which is more likely to exhibit belt slip. A toothed belt is also less sensitive to suboptimal belt tension. However, a motor and/or solenoid device which is separate from the main electric motor 120 of the construction equipment can also be mounted in order to drive the vibration device. This has the advantage of allowing full control of the frequency of the generated vibration by control of the axle speed of the separate electric motor. A separate electric motor can for instance be used to generate a controlled amount of vibration by adding an eccentrically configured weight to the motor axle in a known manner. A solenoid device can be used to “pulse” a weight and thereby generate a controlled amount of vibration. Separate motors and solenoid devices can be used in combination for an increased effect. More than one solenoid device can also be used to reciprocally move respective weights in order to generate different vibration patterns. An uneven rotatable member, such as a gear ring or the like can also be attached to the motor axle or to the tool axle. This rotatable member will generate vibration as it comes into contact with some form of cooperating member. By axially displacing the cooperating member and/or the rotatable member, vibration can be activated and deactivated.

The vibration device can be arranged to generate vibration in a radial and/or in an axial direction with respect to the tool axle 135. The direction of vibration may also be configurable by the user, and some vibration directions may be better than other vibration directions for certain cutting tasks. A machine may also comprise more than one vibration device. For instance, one vibration device may be primarily intended for generating vibration in a radial direction while another vibration device may be primarily intended for generating vibration in an axial direction.

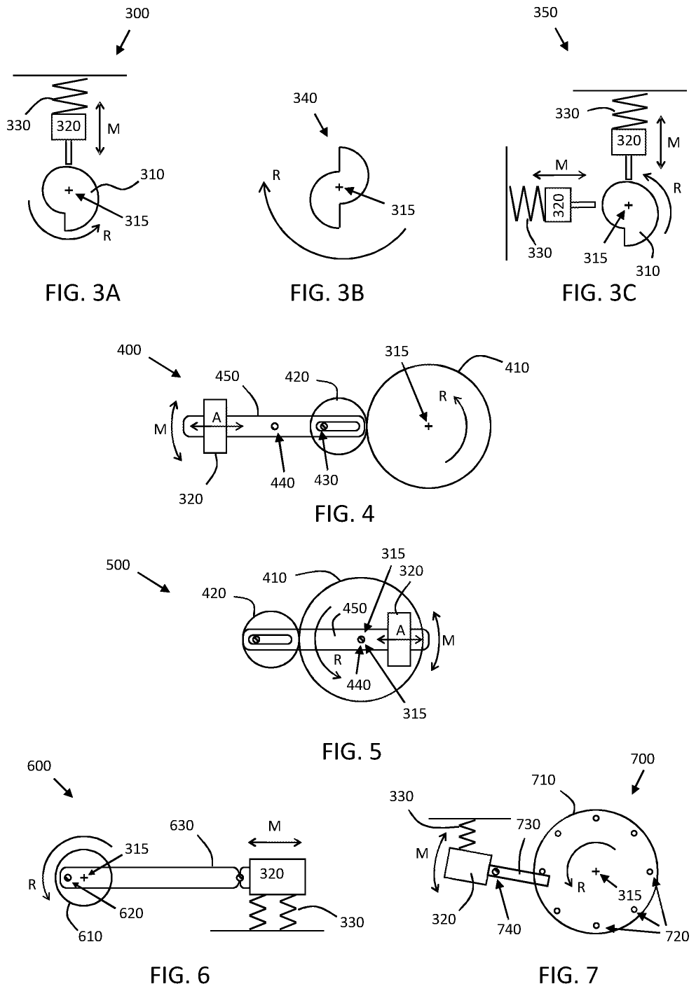

FIGS. 3A-C, and FIGS. 4-7 illustrate some example mechanisms which can be used to generate a controlled amount of vibration.

FIG. 3A shows an example of a vibration device 300 which comprises a mass 320 and spring 330 arrangement. A cam 310 is brought to rotate R about an axis of rotation 315. The cam then engages with a mass 320 that is suspended by one or more springs 330 or other resilient members such as a rubber mounting piece or the like. The mass 320 is brought into reciprocating motion M by the cam 310. The weight of the mass and the characteristics of the spring arrangement, together with the speed at which the cam is rotated and the design of the cam, determines the amplitude and frequency of the generated vibration. The cam 310 can be mounted directly onto the tool axle 135 or directly onto the motor axle 125, or it can be driven via some form of transmission. The transmission can then also be used to translate an axle speed into a desired cam speed by adding an appropriate gear ratio.

A cam arrangement with more than one cam can also be used in order to adjust the frequency of the vibration. FIG. 3B illustrates an example double-cam 340. These cams 310, 340 are also brought to rotate R about an axis of rotation 315.

More than one mass 320 can also be used in order to adjust the amplitude and/or frequency of the vibration generated by the vibration device. FIG. 3C illustrates an example mass-spring system where two masses 320 are brought into reciprocating motion M by a single cam element.

FIG. 4 and FIG. 5 illustrate additional examples 400, 500 of mechanisms that can be used to generate a controlled amount of vibration. These mechanisms comprise a first cogwheel 410 which engages a second cogwheel 420. The second cogwheel 420 comprises a pin 430 or trunnion which engages a lever 450 that pivots about a pivot 440. A mass 320 is attached to the lever 450 which is brought into motion M by the interaction with the lever 450, thereby generating a controlled amount of vibration. The mass 320 can be moved A along the lever 450 to adjust the characteristics of the vibration generated by the vibration device.

FIG. 5 illustrates a more compact version 500 of the vibration device 400. The principle of operation is the same as for the mechanism 400.

FIG. 6 illustrates an example vibration device 600 which is based on a rotating member 610 eccentrically attached via a pin 620 to a lever 630. The lever engages a mass 320 suspended by one or more resilient members, such as springs 330. When the rotating member 610 is brought into rotation R, the mass M will exhibit a reciprocating motion M which generates a controlled amount of vibration.

The rotations R of the rotating members 410, 610, 710 in FIGS. 4-7 are about respective axes of rotations 315, as indicated in the respective Figures.

FIG. 7 shows yet another example 700 of a vibration device. This device comprises a rotating member 710 with pegs 720 distributed around the perimeter of the rotating member 710 that sequentially engage a lever 730 that is rotatably supported about a pivot 740. A mass 320 is brought into reciprocating motion M by the rotation R of the rotating member 710.

FIGS. 3A-C, FIG. 4, FIG. 5, FIG. 6, and FIG. 7 illustrate examples of mechanical vibration devices suitable for generating a controlled vibration. These vibration devices may be driven directly by the main electric motor 120 of the construction equipment 100, 1200, 1300 or by a separate motor dedicated to actuating the vibration device. A clutch mechanism may be arranged in-between the main electric motor 120 and the vibration device in order to allow activation and deactivation of the vibration device by a user, e.g., via the user interface 150. This clutch may be a mechanical clutch, such as a spring-loaded clutch that can be actuated, e.g., by a lever or other control mechanism operable by a user. The clutch may also be an electrically actuated clutch, such as an electromagnetic clutch which can be automatically actuated, e.g., by the control unit 101. The basic principles of clutch mechanisms are generally known and will therefore not be discussed in more detail herein.

Vibration may also be generated directly by an electric motor by controlling the motor currents used to drive the motor. An inverter is often used to generate currents in the motor windings in order to control the motor to operate at a desired target speed and/or at a desired axle torque. If a disturbance is added to these currents, then vibration will result. The magnitude and temporal characteristics of the disturbance determines the amplitude and frequency of the generated vibration. Thus, it is understood that the vibration device may also be constituted by the main electric motor 120 of the construction equipment, which can be used to generate a controlled amount of vibration. The amplitude and/or the frequency of the generated vibration can advantageously be controlled from the control unit 101.

Further advantages can be obtained if the vibration is configurable independently of the rotation speed of the tool axle. This can, for instance, be realized if the vibration is generated by a separate electric motor with an eccentrically arranged weight on its motor axle. The separate electric motor is then preferably arranged close to the tool 130, and distal from the handles 160, 170 used to guide the machine. By arranging a separate motor to generate vibration in this manner, both frequency and amplitude of the vibration can be controlled. A pulsating solenoid arrangement can also be used with similar effect.

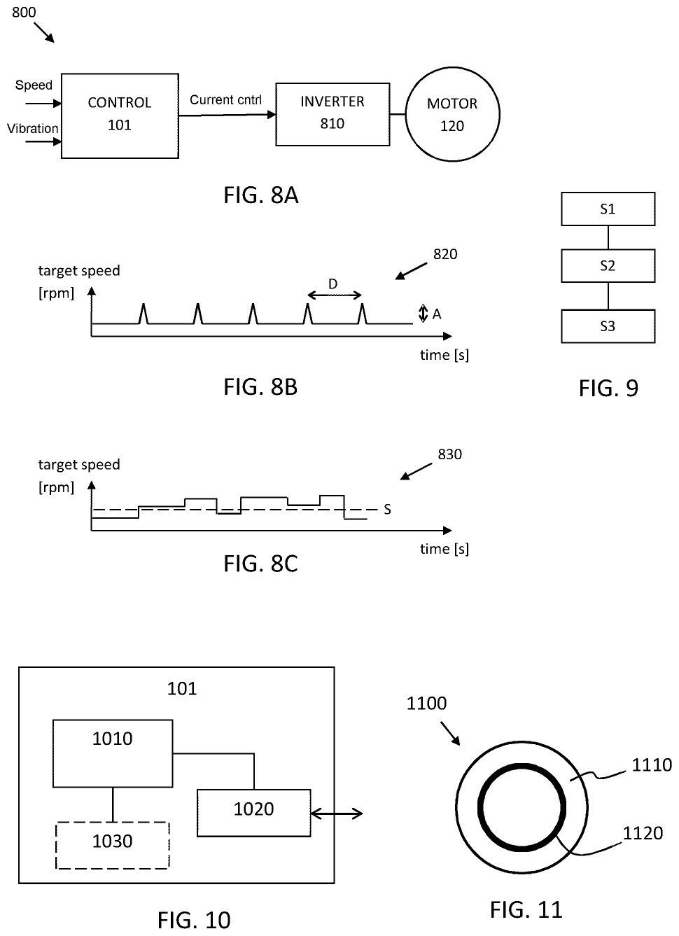

FIG. 8A schematically illustrates an electric motor control system 800 suitable for use with, e.g., the power cutter 100, the wall saw 1200 or the core drill 1300. A control unit 101 receives a speed command and a vibration activation command, which is not needed in case the vibration is always activated. The speed command may, e.g., be received from the trigger 180 on the power cutter 100, from a remote control device 1210 of the wall saw 1200, or from a control interface of the core drill machine 1300. The vibration command indicates if the user desires the vibration function to be activated or not. It may be generated based on user input via the user interface 150. The control unit 101 then controls an inverter 810 which generates motor currents such that the electric motor axle strives to rotate at the configured speed.

In case the vibration command indicates that the vibration function is to be activated, then the control unit 101 adds a disturbance to the current control command issued to the inverter 810 in order to generate vibration by the electric motor. Thus, in this case the motor itself is the vibration device. The control unit 101 may for instance be arranged to generate an inverter control command for control of the electric motor 120 which corresponds to a target motor speed with a variance over time, such as a pulsed speed or a sequence of abrupt speed variations with an amplitude and a frequency in dependence of the type of vibration that it is desired to generate.

The control unit 101 is optionally arranged to control a frequency and/or an amplitude of the vibration by modulating the axle speed command, i.e., the control of the electric motor speed, over time. FIG. 8B-C show example electric motor target speed variation patterns 820, 830. The amplitude of the pulses in FIG. 8B has an impact on the magnitude of the generated vibration. A small amplitude pulse A will give a weaker vibration compared to a larger amplitude pulse. The duration D in-between pulses, i.e., the pulse repetition interval, will affect the frequency of the generated vibrations. A shorter duration in-between pulses will give rise to higher frequency vibration and vice versa. The pulse amplitude A and pulse repetition interval need not be constant, it can be varied over time in order to generate a more complex vibration pattern. For instance, a pseudo-noise (PN) sequence could be suitable for modulating the pulse amplitude and/or the pulse repetition interval over time.

FIG. 8C shows another example target motor speed 830 with a variance over time. In this case the target speed is changed in a random pattern around an average target speed S, such as according to a PN sequence having some configurable amplitude and frequency characteristic. Generally, the magnitude of the changes and the distribution of the time periods in-between changes in target speed will determine the amplitude and frequency of the generated vibration. In both examples 820, 830, the control unit 101 is arranged to control an amplitude and/or a frequency of the vibration by modulating the axle speed command over time.

The electrically powered construction equipment 100, 1200, 1300 may furthermore comprise an inertial measurement unit (IMU) arranged to output a signal indicative of the vibration which is currently generated. The control unit 101 can then be arranged to control the main electric motor 120 based on the IMU output signal to obtain a desired frequency and/or amplitude of vibration.

For instance, the variation of the speed command over time can be adapted in order to generate a desired frequency of vibration and/or a desired vibration amplitude. In case the IMU signal indicates that the frequency content in the currently generated vibration is below a desired frequency, then the target speed disturbance can be adjusted to increase the frequency of the vibration generated by the electric motor, e.g., by reducing the period between pulses or the average time period between target speed changes in a sequence of speed changes like that illustrated in FIG. 8C. The same type of adaptation can be implemented for vibration amplitude. In case the generated vibration is weaker than a desired vibration level, then the amplitude of the disturbance added to the target speed can be increased, and vice versa.

FIG. 9 is a flow chart illustrating a method performed in a control unit 101 for controlling an electric motor 120. The method comprises obtaining S1 a speed command and controlling S2 the electric motor to operate at a target speed in dependence of the speed command. The method further comprises, in response to a vibration activation command, adding S3 a disturbance to the speed control of the electric motor 120 to generate a controlled vibration by the electric motor 120.

FIG. 10 schematically illustrates, in terms of a number of functional units, the components of a control unit 101 according to embodiments of the discussions herein. This control unit may be comprised in the machines 100, 1200, 1300 or elsewhere, such as in a remote device 1210. Processing circuitry 1010, which may be distributed over several units, is provided using any combination of one or more of a suitable central processing unit CPU, multiprocessor, microcontroller, digital signal processor DSP, etc., capable of executing software instructions stored in a computer program product, e.g. in the form of a storage medium 1030. The processing circuitry 1010 may further be provided as at least one application specific integrated circuit ASIC, or field programmable gate array FPGA.

Particularly, the processing circuitry 1010 is configured to cause the control unit 1000 to perform a set of operations, or steps, such as the methods discussed in connection to FIG. 9 and elsewhere herein.

For example, the storage medium 1030 may store the set of operations, and the processing circuitry 1010 may be configured to retrieve the set of operations from the storage medium 1030 to cause the control unit 1000 to perform the set of operations. The set of operations may be provided as a set of executable instructions. Thus, the processing circuitry 1010 is thereby arranged to execute methods as herein disclosed. The control unit comprises processing circuitry 1010, an interface 1020 coupled to the processing circuitry 1010, and a memory 1030 coupled to the processing circuitry 1010, wherein the memory comprises machine readable computer program instructions that, when executed by the processing circuitry, causes the control unit to perform the methods discussed above in connection to FIG. 9.

The storage medium 1030 may also comprise persistent storage, which, for example, can be any single one or combination of magnetic memory, optical memory, solid state memory or even remotely mounted memory.

The control unit 1000 may further comprise an interface 1020 for communications with at least one external device. As such the interface 1020 may comprise one or more transmitters and receivers, comprising analogue and digital components and a suitable number of ports for wireline or wireless communication.

The processing circuitry 1010 controls the general operation of the control unit 1000, e.g., by sending data and control signals to the interface 1020 and the storage medium 1030, by receiving data and reports from the interface 1020, and by retrieving data and instructions from the storage medium 1030. Other components, as well as the related functionality, of the control node are omitted in order not to obscure the concepts presented herein.

FIG. 11 illustrates a computer readable medium 1110 carrying a computer program comprising program code means 1120 for performing the methods illustrated in FIG. 9, when said program product is run on a computer. The computer readable medium and the code means may together form a computer program product 1100.

1. Electrically powered construction equipment comprising an electric motor arranged to power an abrasive cutting tool via a drive arrangement,
the abrasive cutting tool comprising abrasive elements arranged on a carrier of the cutting tool, wherein the abrasive elements are arranged distanced from each other on the carrier and follow a closed path during operation of the electrically powered construction equipment,
the electrically powered construction equipment further comprising a vibration device arranged to generate a controlled amount of vibration of the abrasive cutting tool, wherein the vibration is generated in a frequency band below 15 kHz.

2. The electrically powered construction equipment according to claim 1, wherein the vibration device is arranged to be activated and deactivated in response to a user input signal.

3. The electrically powered construction equipment according to claim 1, wherein the vibration device is arranged to generate vibration at a configurable amplitude and/or frequency.

4. The electrically powered construction equipment according to claim 1, wherein the vibration device is arranged in connection to a tool axle of the construction equipment.

5. The electrically powered construction equipment according to claim 1, wherein the vibration device is arranged to generate vibration in a radial or in an axial direction with respect to the tool axle.

6. The electrically powered construction equipment according to claim 1, wherein the vibration device is arranged to be driven by a main electric motor of the construction equipment.

7. The electrically powered construction equipment according to claim 6, wherein the vibration device is arranged to be driven by a motor or solenoid device which is separate from the main electric motor of the construction equipment.

8. The electrically powered construction equipment according to claim 1, wherein the vibration device comprises a mass and spring arrangement.

9. The electrically powered construction equipment according to claim 6, wherein the main electric motor of the construction equipment constitutes the vibration device.

10. The electrically powered construction equipment according to claim 9, comprising a control unit arranged to control the main electric motor at a target speed with a variation over time.

11. The electrically powered construction equipment according to claim 10, where the control unit is arranged to control a frequency of the vibration by modulating the axle speed command over time.

12. The electrically powered construction equipment according to claim 10, wherein the control unit is arranged to control an amplitude of the vibration by modulating the axle speed command over time.

13. The electrically powered construction equipment according to claim 10, comprising an inertial measurement unit, IMU, arranged to output a signal indicative of the vibration, wherein the control unit is arranged to control the main electric motor based on the IMU output signal to obtain a desired frequency or amplitude of vibration.

14. The electrically powered construction equipment according to claim 1, comprising a user interface configured to trigger activation and deactivation of the vibration device.

15. The electrically powered construction equipment according to claim 1, wherein the control unit-is arranged to generate a non-uniform, random or pseudo-random vibration pattern over time.

16. The electrically powered construction equipment according to claim 1, wherein the equipment is any of a power cutter, a wall saw, a core drill, an abrasive ring saw, or an abrasive chain saw.

17. The electrically powered construction equipment according to claim 1, wherein the vibration is generated in a frequency band below 5 kHz.

18. The electrically powered construction equipment according to claim 1, comprising an automatic vibration activation mechanism, wherein the vibration device is arranged to be automatically activated and deactivated in response to a signal from the automatic vibration activation mechanism.

19. The electrically powered construction equipment according to claim 18, wherein the automatic vibration activation mechanism comprises a control unit and any of: a timer, an inertial measurement unit, IMU, a microphone, and/or a dust generation sensor configured to measure an amount of generated dust by the construction equipment.

20. The electrically powered construction equipment according to claim 18, wherein the signal from the automatic vibration activation mechanism is associated with a torque output from a motor of the electrically powered construction equipment in use.

21. A method performed in a control unit for controlling an electric motor, the method comprising
obtaining a speed command,
controlling the electric motor to operate at a target speed in dependence of the speed command, and,
in response to a vibration activation command,
adding a disturbance to the speed control of the electric motor to generate a controlled vibration by the electric motor.
